(19) United States
(12) Patent Application Publication
(10) Pub. No.: US 2002/0131805 A1
(43) Pub. Date: Sep. 19, 2002

(54) Paper store in a printing machine

(76) Inventors: Cumar Sreekumar, Penfield, NY (US); Lutz Rebetge, Kiel (DE)

Correspondence Address: Lawrence P. Kessler, Patent Department, NexPress Solutions LLC, 1447 St. Paul Street, Rochester, NY, 14653-7103, US

(21) Appl. No.: 09/811,710

(22) Filed: Mar. 19, 2001

(51) Int. Cl. B41J 29/00

(52) U.S. Cl. 400/719

(57) ABSTRACT

A paper store in a printing machine. Printing material, in particular paper, can become wavy and deform as a result of the action of changing temperatures and, in particular, high atmospheric humidity. This causes paper blockages in the printing machine and impairs the printed result. This problem occurs, in particular in the paper store, since here paper sheets are sometimes stored for a relatively long time outside their packaging. Therefore, a paper store is provided, which always preserves printing material without impairing its condition, being enclosed in a substantially airtight manner.

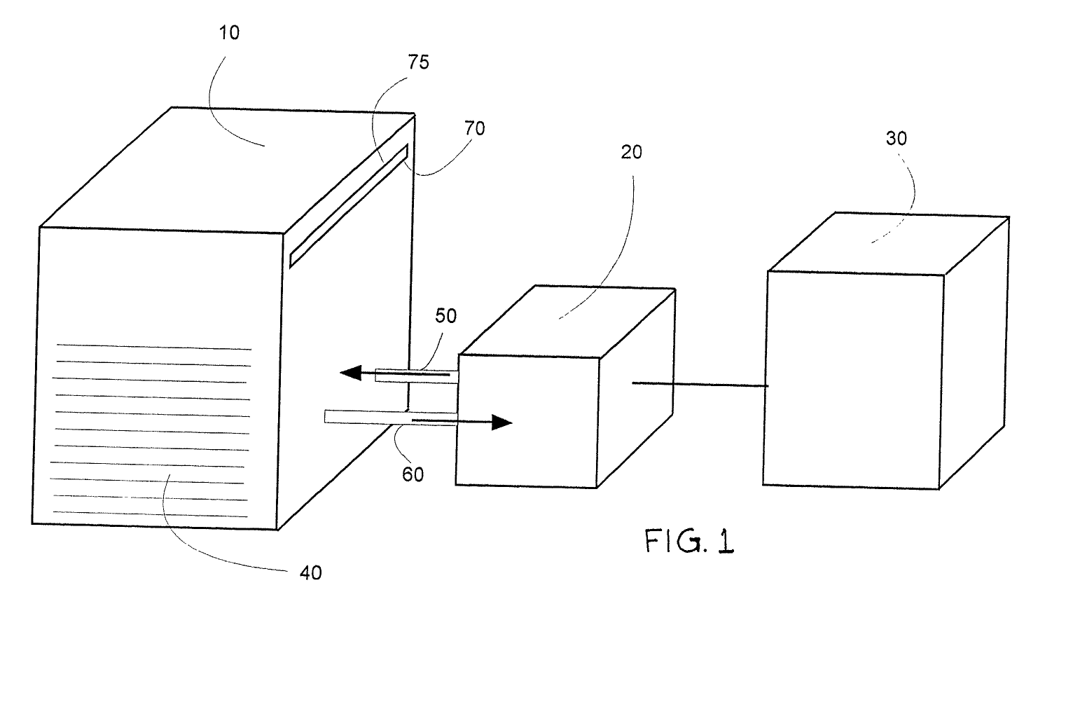

### FIELD OF THE INVENTION

The invention relates to a paper store in a printing machine, the paper store being enclosed in a substantially airtight manner.

### BACKGROUND OF THE INVENTION

In the printing industry, different materials are printed, which are most usually paper and board materials, for example for multifarious publications, packages or labels. In the case of printing paper, a distinction is drawn in terms of the printing material used between sheet-fed and web-fed printing. In web-fed printing, the printing is carried out by the printing machine page for page on a reel of paper which unwinds; in the case of sheet-fed printing, different formats are printed on individual paper sheets, similar to the convention desk top printers for private applications, which most often use paper in the DIN A4 format. The printing machine section for storing and feeding the paper sheets to be printed into the printing machine is designated the feeder, and in this printing machine section there is a paper store to accommodate the paper sheets, from which the printing machine draws its paper supply. Following their manufacture, paper sheets are conventionally introduced in a package, which protects them against environmental influences and ensures an atmospheric humidity, which preserves the shape and smoothness of the paper sheets. However, after the packaging has been removed, the paper sheets are exposed to a different temperature and, in particular, a different atmospheric humidity. This can lead to waviness and dimensional changes of the paper sheets, which ultimately cause paper blockages in the printing machine and impair the printed result. This problem occurs in particular in the paper store, since here paper sheets are sometimes stored for a relatively long time outside their packaging.

### SUMMARY OF THE INVENTION

In view of the above, this invention is directed to avoid dimensional changes of the paper sheets.

According to the invention, the object is achieved by a paper store in a printing machine being enclosed in a substantially airtight manner, that is to say by providing a paper store, which preserves the printing material continuously without impairing its condition. With this feature, the printing material maintains its inherent moisture content.

Specific developments are explained in the dependent claims. In addition, the paper store can have a specific, constant temperature range, which has a beneficial effect on a constant printing-material moisture content. In a similar way, a specific constant atmospheric humidity range in the paper store is advantageous.

An air-conditioning apparatus contained in the printing machine to provide a specific temperature and atmospheric humidity for printing modules in the printing machine feeds conditioned air to the paper store. The air-conditioning apparatus is already present in the printing machine, so that the provision of additional air-conditioning apparatus is dispensed with. With this feature, the object according to the invention can be achieved with minimum outlay.

In one development of the invention, a deviation from the specific temperature and/or atmospheric humidity ranges produces a signal to a control device of the printing machine. By this means, failure of the paper store is determined quickly and the continuous operation of the paper store is ensured. A delivery opening in the paper store, needed to deliver the printing material from the paper store into the printing machine, can be closed in a substantially airtight manner outside the operation of the printing machine. In this way, a further improvement in the sealing properties of the invention is achieved.

The invention, and its objects and advantages, will become more apparent in the detailed description of the preferred embodiment presented below.

### BRIEF DESCRIPTION OF THE DRAWINGS

In order to explain the invention, a description is given below with reference to the appended single FIGURE, which is a schematic illustration of the paper store according to the invention.

### DETAILED DESCRIPTION OF THE INVENTION

Referring now to the accompanying drawings, the FIGURE shows a schematic representation of a paper store 10, which is used as a paper supply or printing-material supply of any desired printing machine (not illustrated). In this connection, the term paper store 10 is to be understood to mean any container associated with a printing machine to accommodate printing material 40. From the paper store 10, the printing machine receives the printing material 40, usually paper or board, which is removed in various ways from a stack of the printing material 40 and, in the FIGURE, is represented by horizontal lines. The printing material 40 may consist of other materials, in particular film, board, paper board or plastic.

If the printing material 40 is stored for a certain time in the paper store 10 of the printing machine, that is to say if, after a print job, there is a residue of printing material 40 in the paper store 10, or if the print job is delayed, the printing material 40 undesirably picks up humidity from the surrounding air in the paper store 10. This humidity, increased in comparison with the surroundings of the printing machine, stems from the printing machine. According to the invention, the paper store 10 is sealed off in a substantially airtight manner with respect to the surroundings. To this end, the paper store 10 and the material connections, the edges of the paper store 10, are provided with sealing material. The paper store 10 has a drawer for the paper to be put in, the edges of said drawer being provided with sealing material. When the drawer is closed, the paper store 10 is substantially sealed off with respect to the surroundings.

One variant of the invention is for the paper store 10 to be assigned an air-conditioning apparatus 20, in this case the air-conditioning apparatus 20 is connected to the paper store 10 from outside the latter and has at least one feed 50 and one outlet 60 to feed in and let out conditioned air, and, in each case, connecting lines to the paper store 10. Conditioned air is air from an air-conditioning apparatus 20 having essentially desired constant temperature and humidity values. The quantity of air supplied is determined by the desired action, that is to say the temperature and atmospheric humidity to be reached in the paper store 10. The conditioned air is distributed in the paper store 10 and provides a specific climate in the interior of the paper store 10, that is to say specific, substantially constant values of the temperature and humidity range. Excess air is removed from the paper store 10 through an outlet 60. This fact is represented by the arrow directed out of the paper store 10. The air-conditioning apparatus 20 can either be connected permanently or detachably to the paper store 10 and can be installed in existing paper stores 10.

Another possibility is to use an existing air-conditioning apparatus 20 or ECS (Environmental Control System) which is integrated in the printing machine and used to provide constant temperature and humidity for the printing modules of the printing machine. When the ECS is used as an air-conditioning apparatus 20, further material outlay is avoided, the paper store 10 needing no additional air-conditioning apparatus 20. In this design, with the use of an existing integrated air-conditioning apparatus 20 or ECS, in addition to the existing equipment level of the printing machine, only a feed 50 and an outlet 60 between the ECS and the paper store 10 are required in order to preserve the printing material without impairing its condition. This is all the more advantageous, since, in a printing machine, the ECS for providing suitable temperature and atmospheric humidity for its printing modules can be arranged directly adjacent to the paper store 10. This permits the outlay on material and construction to be reduced further, through short lines for feed 50 and outlet 60. The air-conditioning apparatus 20 usually has a coolant circuit with a compressor, refrigerant, evaporator, liquifier, expansion valve, and a fan.

In addition, in the FIGURE a control device 30 of a printing machine is connected to the air-conditioning apparatus 20 via a line. Using the control device 30, the operating sequences of the printing machine are controlled and monitored in the usual manner; this can be a control desk of any desired printing machine or a personal computer with the software suitable for the respective printing machine, and therefore comprises display and input units. In addition, desired values for temperature and atmospheric humidity ranges for various printing materials 40 can be input via the control device 30, and are accepted by the air-conditioning apparatus 20. As a result, the paper store 10 has a specific temperature and humidity range during operation, that is to say when the paper store 10 contains printing material 40, for example paper sheets. In this case, the temperature range is of interest in particular because of the close relationship with atmospheric humidity since, as is known, changes in the temperature lead to changes in the atmospheric humidity.

The control device 30 also automatically controls a closure 70, which is used for the substantially airtight closure of a delivery opening 75 in the paper store 10 when the printing machine is not operating. As soon as a print job has been finished and no further job is waiting, a signal comes from the control device 30 and has the effect of closing the closure 70 over a delivery opening 75 through which, during operation, the printing material 40 is fed into the printing machine from the paper store 10. In a similar way, the closure 70 is opened in order to open the paper path from the paper store 10 to the printing machine as soon as a print job is waiting at the printing machine. The closure 70 comprises a tiltable flap which is provided with sealing material on its inner side. After the closure 70 has been closed, the paper store 10 is substantially completely sealed off with respect to the surroundings.

In a further embodiment of the invention, a thermometer and a hygrometer for determining the temperature and the atmospheric humidity, respectively, are fitted in the paper store 10 and included by the air-conditioning apparatus 30. The thermometer and the hygrometer measure the temperature and the atmospheric humidity in the paper store 10 continually. The values obtained are compared with desired values in a control operation in the air-conditioning apparatus 20, and the air-conditioning apparatus 20 compensates for deviations between the measured and the desired values in a known way. In this case, cool or warm air is fed to the paper store 10, or moist air is let out through the outlet 60 and replaced by air with a suitable moisture content. In this way, a temperature range and an atmospheric humidity at which no waviness and deformation occurs on the printing material 40 are available to the printing material 40 at any time.

In the event of a failure or disruption to the air-conditioning apparatus 20, or if, for any other reasons, the temperature and atmospheric humidity range in the paper store 10 deviates from the corresponding desired values and cannot be regulated, the air-conditioning apparatus 20 sends a signal to the control device 30 via a connecting line, said signal having the effect of a message in the display unit of the control device 30, so that an operator of the printing machine can be informed about the undesired state. Reference should be made to the fact that the invention can be applied to any type of paper store 10, although this has been described in this case only with reference to sheet printing at the feeder of a printing machine. A further application is paper stores 10 in copiers.

The invention has been described in detail with particular reference to certain preferred embodiments thereof, but it will be understood that variations and modifications can be effected within the spirit and scope of the invention.

What is claimed is:

1. A paper store (10) in a printing machine, wherein the paper store (10) is enclosed in a substantially airtight manner.

2. The paper store (10) in a printing machine as claimed in claim 1, wherein the interior of the paper store (10) has a specific, constant temperature range.

3. The paper store (10) in a printing machine as claimed in claim 2, wherein the interior of the paper store (10) has a specific, constant atmospheric humidity range.

4. The paper store (10) in a printing machine as claimed in claim 3, wherein it is possible to feed the paper store (10) with conditioned air from an air-conditioning apparatus (20) for providing specific temperature and atmospheric humidity for printing modules in the printing machine.

5. The paper store (10) in a printing machine as claimed in claim 4, wherein any deviation from the specific temperature and/or atmospheric humidity ranges in the paper store (10) produces a signal to a control device (30) of a printing machine.

6. The paper store (10) in a printing machine as claimed in claim 5, wherein a temperature and/or atmospheric humidity range can be controlled by means of a control loop of the air-conditioning apparatus (20).

7. The paper store (10) in a printing machine as claimed in claim 6, wherein the paper store (10) is equipped with material of a high thermal resistance and a low permeability to humidity.

8. The paper store (10) in a printing machine as claimed in claim 7, characterized by a closure (70) for the substantially airtight closure of a delivery opening (75) on the paper store (10) outside operation.

9. The paper store (10) in a printing machine as claimed in claim 8, wherein the closure (10) can be opened and closed by the control device (30).
